(19) United States
(12) Patent Application Publication
(10) Pub. No.: US 2015/0107520 A1
(43) Pub. Date: Apr. 23, 2015

(54) Cat scratcher and lounge system

(71) Applicant: Michael Russell Durnen, Spokane, WA (US)

(72) Inventor: Michael Russell Durnen, Spokane, WA (US)

(21) Appl. No.: 13/998,316

(22) Filed: Oct. 21, 2013

(51) Int. Cl. A01K 15/02; A01K 1/035

(52) U.S. Cl. CPC A01K 15/024; A01K 1/035
USPC 119/28.5

(57) ABSTRACT

A cat scratcher lounge system for providing a combination of a scratcher and lounge with replaceable scratching materials. This system includes a frame being capable of accepting two cylindrical scratching inserts, the frame having sides and a top portion suitable for forming a resting and/or sleeping place for a cat including two opening, one at the each end for insertion and removal of the scratching cylinders. This system is configured so as to be able to rotate scratching cylinders 90 degrees providing four surfaces for scratching and then replacing the scratching cylinder unit as the four scratching surfaces become degraded upon use. These scratching cylinders can provide alternative scratching surfaces such as corrugated cardboard, sisal and carpet which can be configured in different combination in the cat lounger providing alternative scratching materials for the cat at the same time.

### RELATED APPLICATIONS

The present application is a continuation-in-part application of U.S. provisional patent application Ser. No. US61/796,144, filed Nov. 5, 2012, for SCRATCH-N-SNOOZ, by Michael Russell Durnen, included by reference herein and for which benefit of the priority date is hereby claimed.

### FIELD OF THE INVENTION

The present invention relates to a cat scratcher lounge . . . and, more particularly, to a cat scratcher lounge that has replacement cylindrical scratching cartridges made of corrugated cardboard, sisal, or carpet . . . This system includes a frame with opening at both ends so as to insert cylindrical scratching cartridges of common cat scratching materials which can be rotated 360 degrees to expose four new scratching surfaces.

### BACKGROUND OF THE INVENTION

It has been well established that cats sleep for many hours each day and they have a need to to sharpen their claws by scratching on material such as cardboard, carpet, fabric or other materials they can find. Currently there are many cat products that address the sleeping and scratching needs of cats. To this end there is a category of cat products that has combined the sleeping and scratching function into one product. The normal material used for these types of products is corrugated cardboard that is cut to a specific shape and size and glued together so as to form a resting place suitable in length and width for cats to sleep and to further provide for a place to satisfy their scratching needs. These products are illustrated by design patents U.S. Design Pat. No. 655,463 S, issued on Mar. 6, 2012 to Seliskar et al. entitled Cat Scratcher. Another design patent is U.S. Design Pat. No. 589,657 S, issued on Mar. 31, 2009 to Lamstein entitled Cat Chaise. Additional design patent is U.S. Design Pat. No. 582,611 S., issued on Dec. 9, 2008 to Bise entitled Pet Bed. Yet another design patent is U.S. Pat. No. 651,770 S, issued Jan. 3, 2012 to Seliskar et al. entitled Cat Scratcher.

Current prior art has many disadvantages for both the cat owner and the cat. It is well know that cats have individual personalities and can be very selective when it comes to the types of toys, food, scratching material that they prefer. So having only corrugated cardboard material for the construction of the cat lounger will not meet the needs of all cats. Also, having corrugated cardboard scratcher can be very messy after the cat(s) have sharpened their claws and the shredded cardboard pieces are tracked all over the house. Another problem with the prior art is that once the the scratcher lounger unit has been used to the degree that it no longer is suitable for scratching and no longer looks presentable, the complete lounger unit needs to be replaced. Yet another disadvantage of the current scratcher lounges is that they are limited to corrugated cardboard construction which limits the styling that can be offered to the consumer.

It is an object of the invention to provide a cat scratcher lounge so as the scratching material can be replaced when needed without replacing the total unit.

It is an object of the invention to provide a cat scratcher lounge that can use all current scratching materials such as corrugated cardboard, sisal, and carpet material.

It is another object of this invention to provide cylinders that are covered in material suitable for scratching, such as corrugated cardboard, sisal, and carpet.

It is further object of the invention to provide openings at both ends of the lounger so as to be able to insert cylinders of different scratching materials at the same time.

It is another object of this invention to provide cylindrical scratching cartridges that can be rotated 360 degrees 90 degrees at a time exposing four equal portions of the scratching material.

It is an object of this invention to provide a lounger frame that can be constructed from many kinds and colors of materials.

### SUMMARY OF THE INVENTION

In accordance with the present invention, there is provided . . . cat scratcher lounge consisting of a frame forming the lounge section with openings at both ends to accept cylindrical scratching cartridges that can be inserted and removed for rotation to expose the four portions of the scratching cylinders that can be constructed from various types of scratching materials and aiding in the replacement of scratching cartridges once they are no longer suitable for that purpose.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of present invention of a scratcher lounge frame with cylindrical scratching cartridges comprised of corrugated cardboard at both ends;

FIG. 2 is a top view of the present invention of a scratcher lounge frame with cylindrical scratching cartridges comprised of corrugated cardboard at both ends;

FIG. 3 is an end view of present invention of a scratcher lounge frame and cylindrical scratching cartridge comprised of corrugated cardboard;

FIG. 4 is a side view of present invention of a scratcher lounge frame; and

FIG. 5 is an exploded view of present invention of a scratcher lounge frame with guides for inserting a square tube into the frame with scratching material position to be inserted over square tube forming a cylindrical scratching cartridge of corrugated cardboard.

For purposes of clarity and brevity, like elements and components will bear the same designations and numbering throughout the Figures.

### DESCRIPTION OF THE PREFERRED EMBODIMENT

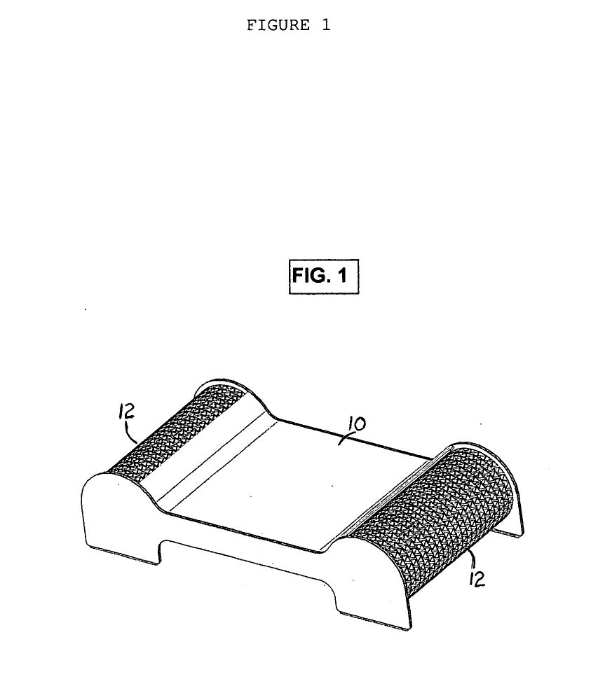

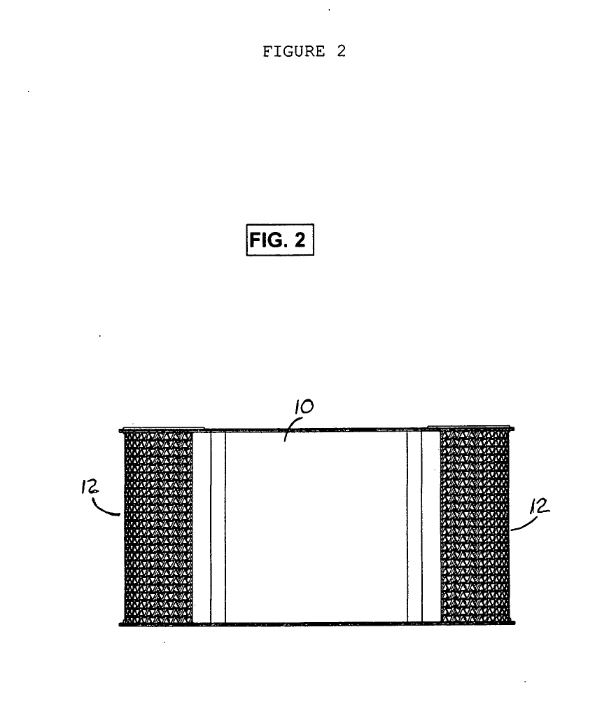

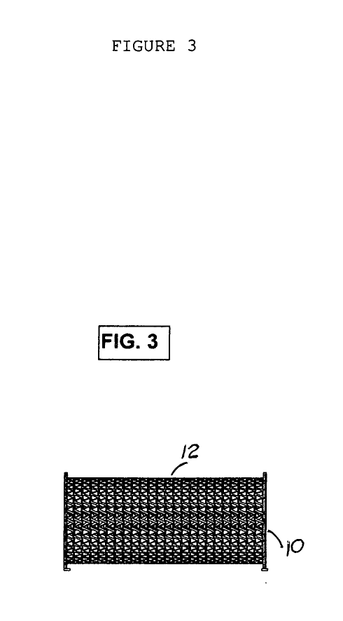

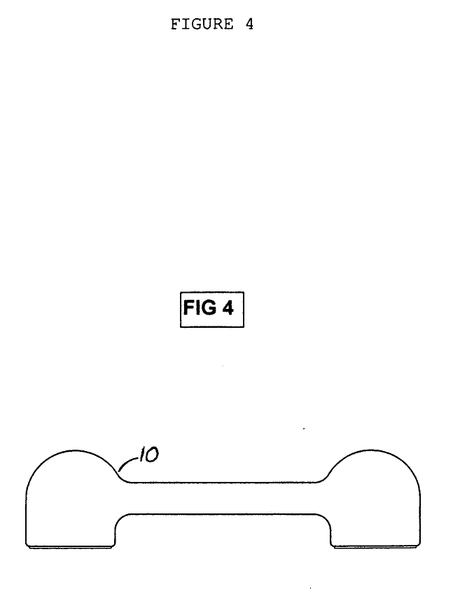

Turning in detail to the drawings, FIG. 1 illustrates a cat scratcher lounge system having a frame 10 forming the lounge portion of the present invention that has openings at both ends that can be formed of material such as plastic or metal and uses standard forming methods, such as, but not limited to, injection molding, vacuum molding and stamping to form a shape suitable for a cat to rest upon and have openings that contain a groove 13 to accept and lock in the square tube 11 with attached scratching cylinder 12 which can be formed from various material such as corrugated cardboard, sisal, or carpet. FIG. 2 shows the top view of frame 10 with a scratching cylinder 12 at both ends. FIG. 3 is another view showing one end of the scratcher lounge with a scratching cylinder comprised of corrugated cardboard inserted and locked into the frame 10. FIG. 4 show the side view of present invention.

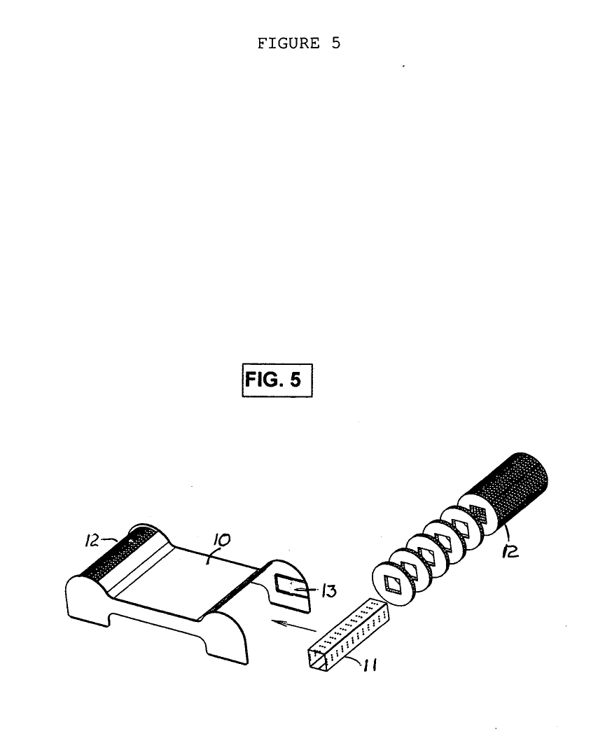

Turning to FIG. 5, shows key elements of the present invention with the goal of providing a reusable frame 10 that can use replaceable scratching cylinder 12 of corrugated cardboard. Said corrugated cardboard can be formed from individual disc glued together as to form a cylindrical shaped or provided as individual discs that can be placed over the square tube 11 before inserting into the groove 13 of the frame 10. Further embodiments of the cylindrical scratching tube, but not limited to, is the construction of said cylinder that is comprised of scratching materials such as sisal and carpet. Also shown in FIG. 5 is the square tube 11 being inserted into the groove 13 at one end of the frame 10 while the other end shows scratching cylinder 12 installed and locked into place.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A cat scratcher and lounge system for providing a bed for resting and/or sleeping that contains cylindrical scratching cartridges of various scratching materials that can be replaced and are interchangeable at both ends of the lounge frame, comprising:
means for providing a surface suitable for a cat to use as a lounger and has opening at both ends to accept cylindrical cartridges of various scratching materials;
means for the insertion of the scratching cylinder into the frame and securing it until removed and rotated to expose the unused scratching surfaces, for providing a surface suitable for a cat to use as a lounger and has opening at both ends to accept cylindrical cartridges of various scratching materials;
means to attach the scratching cylinder to for the insertion into the frame, manually inserted to said means for the insertion of the scratching cylinder into the frame and securing it until removed and rotated to expose the unused scratching surfaces; and
means for forming a cylindrical scratching cartridge of corrugate cardboard, sisal, or carpet so as to be secured to the square tube prior to the insertion into the frame openings manually.

2. The cat scratcher and lounge system in accordance with claim 1, wherein said means for providing a surface suitable for a cat to use as a lounger and has opening at both ends to accept cylindrical cartridges of various scratching materials comprises a plastic, metal, and said frame contains grooves for the insertion of the square tube, formed from single or multiple parts.

3. The cat scratcher and lounge system in accordance with claim 1, wherein said means for the insertion of the scratching cylinder into the frame and securing it until removed and rotated to expose the unused scratching surfaces comprises a slot for holding and securing square tube

4. The cat scratcher and lounge system in accordance with claim 1, wherein said means for providing a means to attach the scratching cylinder to for the insertion into the frame comprised of various material

5. The cat scratcher and lounge system in accordance with claim 1, wherein said means for forming a cylindrical scratching cartridge of corrugate cardboard, sisal, or carpet so as to be secured to the square tube prior to the insertion into the frame openings.

6. A cat scratcher and lounge system for providing a bed for resting and/or sleeping that contains cylindrical scratching cartridges of various scratching materials that can be replaced and are interchangeable at both ends of the lounge frame, comprising:
of plastic, metal frame, formed from single or multiple parts with grooves for the insertion of the square tube, providing a surface suitable for a cat to use as a lounger and has opening at both ends to accept cylindrical cartridges of various scratching materials;
a slot for holding and securing square tube for the insertion of the scratching cylinder being placed into the frame and securing it until removed and rotated to expose the unused scratching surfaces.

7. A cat scratcher and lounge system for providing a bed for resting and/or sleeping that contains cylindrical scratching cartridges of various scratching materials that can be replaced and are interchangeable at both ends of the lounge frame, comprising:
of plastic, metal frame, containing grooves for the insertion of the square tube, frame formed from single or multiple parts for providing a surface suitable for a cat to use as a lounger and has opening at both ends to accept cylindrical cartridges of various scratching materials;
a slot for holding and securing square tube, for the insertion of the scratching cylinder into the frame and securing it until removed and rotated to expose the unused scratching surfaces
